(19) United States
(12) Patent Application Publication
(10) Pub. No.: US 2012/0291182 A1
(43) Pub. Date: Nov. 22, 2012

(54) FLOATATION DEVICE FOR CAP

(76) Inventor: Gregory V. Kovanda, Lake Forest, IL (US)

(21) Appl. No.: 13/475,052

(22) Filed: May 18, 2012

Related U.S. Application Data
(60) Provisional application No. 61/519,108, filed on May 18, 2011.

(51) Int. Cl. A42B 1/24; C09J 7/02; B32B 7/12; B32B 33/00

(52) U.S. Cl. 2/209.13; 428/41.8

(57) ABSTRACT

A floatation device for attachment to a cap for preventing the cap from sinking when dropped in a body of water. The floatation device includes a planar sheet of buoyant material and an adhesive layer adhered to one side of the sheet. A removable release liner is disposed on the adhesive layer such that the release liner can be removed to expose the adhesive layer for attachment of the sheet to the bill of the cap.

### CROSS-REFERENCE TO RELATED APPLICATIONS

This application claims the benefit of U.S. Provisional application No. 61/519,108, filed May 18, 2011, the disclosure of which is incorporated herein by reference.

### BACKGROUND OF THE INVENTION

This invention relates in general to flotation devices and, in particular, to a flotation device which is attached to a hat or cap to help prevent the cap from sinking if dropped in a body of water.

Ball caps have become increasingly popular in recent times. Ball caps have a rounded crown or main body that is generally made of a soft material and include a generally stiff brim or bill that extends outwardly from a front edge of the cap. The bill may be curved or flat. The bill provides shade for the wearer's eyes and face. Ball caps often include ornate indicia and may become a favorite cap that is worn many times by the wearer.

For fisherman, outdoorsman, and recreational boaters it is not uncommon to have the cap blown off the wearer's head. Depending on the type of materials the cap is made of, the cap may sink if accidentally dropped in a body of water, such as a stream or a lake. U.S. Pat. No. 1,552,459 discloses the use of a cork ball formed in the top of a bathing cap by stitching the ball under a fabric. Although this design may provide adequate buoyancy of the bathing cap, the necessity of the relatively large size of the ball is unsightly. Additionally, the cork ball is attached during the manufacture of the bathing cap and is not able to be attached to a later manufactured or different cap. It is also known to attach tethers which clip onto the cap and are either looped around the wearer's neck or clipped to the wearer's shirt to help capture the cap if blown off the wearer's head. However, such tethers may be uncomfortable to wear and can also be unsightly.

### SUMMARY OF THE INVENTION

This invention relates to floatation devices and, in particular, a floatation device for attachment to a cap for preventing the cap from sinking when dropped in a body of water. The floatation device includes a planar sheet of buoyant material and an adhesive layer adhered to one side of the sheet. A removable release liner is disposed on the adhesive layer such that the release liner can be removed to expose the adhesive layer for attachment of the sheet to the bill of the cap.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a perspective view of an underside of a ball cap having a floatation device adhered to the bill of the cap.

FIG. 2 is a top plan view of the floatation device illustrated in FIG. 1.

FIG. 3 is a cross-sectional view taken along lines 3-3 in FIG. 2.

### DETAILED DESCRIPTION OF THE PREFERRED EMBODIMENT

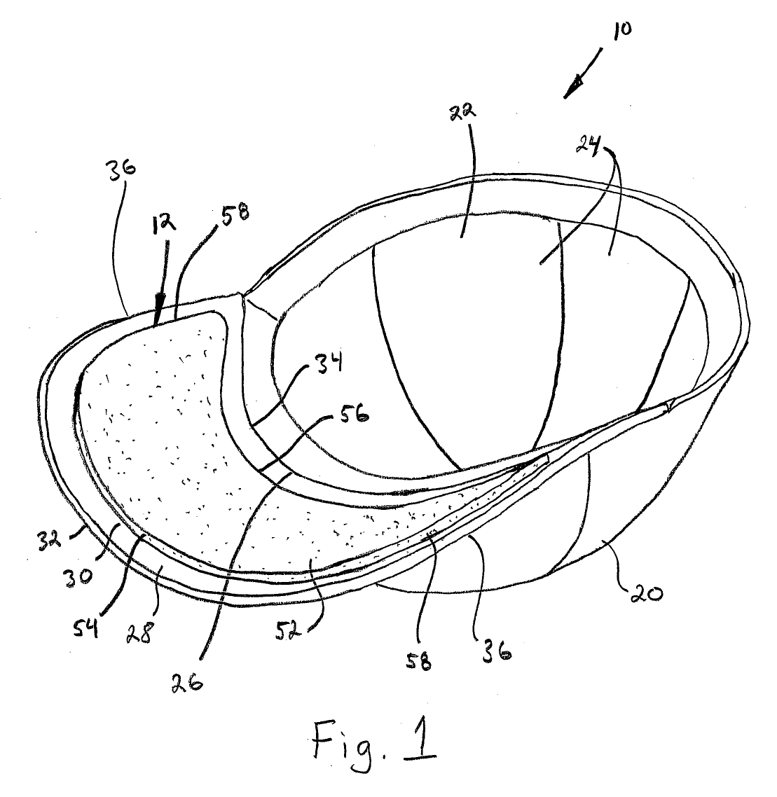

Referring now to the drawings, there is illustrated in FIG. 1 a ball cap, indicated generally at 10. As will be described in detail below, a floatation device, indicated generally at 12, is attached to the cap 10. The floatation device 12 helps keep the cap 10 afloat should it be dropped into a body of water. Although the floatation device 12 is shown being used with the cap 10 as illustrated in FIG. 1, it should be understood that the floatation device 12 may be used with any suitable hat, cap, visor or other item and is not limited to the specific example of the cap 10 shown and described herein.

The cap 10 includes a rounded crown or main portion 20 having an interior 22. The main portion 20 is sized and configured to fit over the head of a wearer of the cap 10. The main portion 20 can be made of any suitable material, such as cloth or plastic. In the embodiment shown in FIG. 1, the main portion 20 of the cap 10 is made of a plurality of panels 24 which are sewn together. Extending from an edge 26 of the main portion 22 is a bill 28. The bill 28 extends outwardly from the edge 26 and generally provides for shade and protection to the face of the wearer of the cap 10. The bill 28 may be relatively thin and may have a flat or curved shape. The bill 28 includes an underside surface 30 and an upper surface (not shown in FIG. 1). The bill 28 further includes a front edge 32, a rear edge 34, and a pair of side edges 36. The bill 28 may be made of any suitably stiff material and may be attached to the edge 26 of the main portion 20 of the cap 10 by any suitable manner, such as by stitching. For example, the bill 28 may be made of a generally rigid plastic or felt inner layer (not shown) which is wrapped by a cloth material to cover the upper surface and the underside surface 30. The inner layer may be flexible enough to be folded or formed into a desired curved shape. Of course, the bill 28 can have any desired shape and is not limited to the shape shown in FIG. 1.

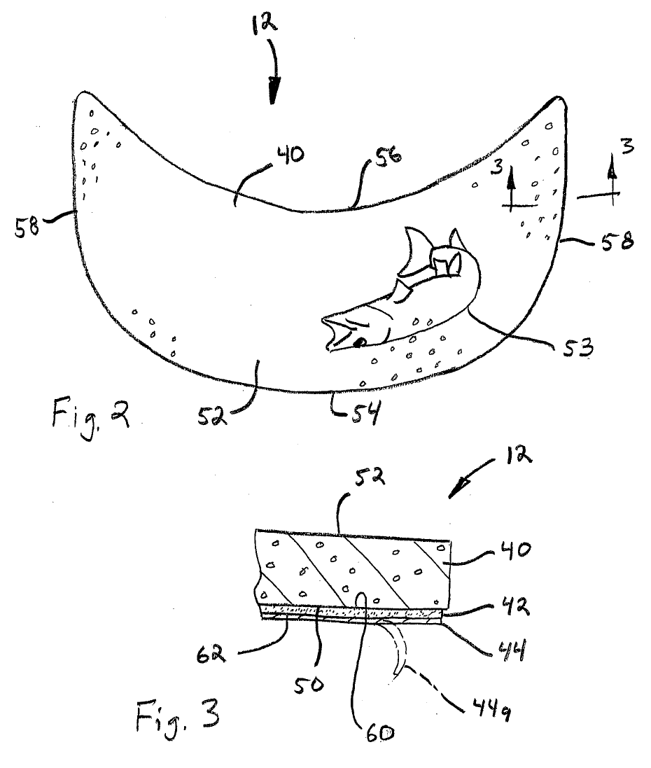

As shown in FIGS. 2 and 3, the embodiment of the floatation device 12 includes a body 40, an adhesive layer 42, and a release liner 44. The body 40 of the floatation device 12 may be in the form of a flexible flat planar sheet which is sized to accommodate the size and shape of the underside surface 30 of the bill 28 of the cap 10, as shown in FIG. 1. The body 40 may be manufactured having a constant cross-sectional thickness across its entire length or may be made with varying thicknesses. The generally flat body 40 has an attachment side 50 adjacent the adhesive layer 42, and an exposed side 52. If desired, the exposed side 52 may include indicia, such as for example the fish indicia 53, printed or formed thereon. If printed, any suitable ink can be used. Alternatively, the indicia 53 can be in the form of a label, sticker, or another layer attached to the exposed side 52. Of course, the exposed side 52 may also be free of any indicia thereon.

As shown in FIGS. 1 and 2, the body 40 of the floatation device 12 includes a front edge 54, a rear edge 56, and side edges 58. The body 40 may be shaped and sized so as to substantially cover the underside surface 30 of the bill 28 of the cap 10, as shown in FIG. 1. As illustrated in FIGS. 1 and 2, the rear edges 34 and 56 of the bill 28 and the body 40, respectively, have a curved shape to accommodate the rounded shape of the main portion 20. The front edges 32 and 54 of the bill 28 and the body 40, respectively, may also have a curved shape. Although the floatation device 12 need not substantial cover the underside surface 30 of the bill 28, a substantial covering enables the thickness of the body 40 to be reduced since the volume of the cork can be spread out and need not be of great thickness to obtain a desired volume of cork. Additionally, the substantial covering of the underside surface 30 of the bill 28 by the body 40 provides an aesthetically pleasing appearance. The edges 54, 56, and 58 of the body 40 may line up with the edges 32, 34, and 36 of the bill 28 or may be spaced apart therefrom, as shown in FIG. 1. It may be desirable to provide a body 40 having slightly smaller dimensions than a common or typical ball cap so that the body 40 is likely to fit on most ball caps. It may also be desirable to manufacture the body 40 slightly larger so that it can be cut to size by the consumer to any desired dimension. Thus, it should be understood that the body 40 may be made to cover the entire area of the underside surface 30 of the bill 28 or a smaller area of the underside surface 30.

It is preferred that the body 40 of the floatation device 12 is generally made of a material that is flexible so that it can be shaped and formed with the flexible bill 28 of the cap 10 when installed thereon. The body 40 may be made of a single part, as shown in FIGS. 1 and 2, or may be comprised of multiple parts that may be connected together or separate from one another. The body 40 may also be made of separate layers connected together that may or may not be made of similar materials.

The body 40 is preferably made of a buoyant material such that it is buoyant in water and will float on top of the water rather than sink. It is also desirable that the buoyant material has a relatively high buoyancy characteristic that when attached to the bill 28 of the cap 10, the combined buoyant properties of the cap 10 and the floatation device 12 will also prevent the cap 10 from sinking when dropped in a body of water regardless of whether the cap 10 is buoyant by itself or not. Although the body 40 of the floatation device 12 may be made of any suitable buoyant material, one preferred material is cork. The cork can be natural or synthetic. One such suitable material is an agglomerated composition cork produced with about 0.5 mm granulated cork with a polyurethane binder. It has been found that this agglomerated composition of cork having a thickness of between about 0.0625 inches to about 0.125 inches is sufficient to keep a conventional ball cap afloat. Cork not only has a desired buoyancy rate to weight ratio, but is also durable, water resistant, flexible, and has a generally overall aesthetically pleasing appearance. Plastic foam is also a suitable material for the body 40.

The adhesive layer 42 can be any suitable adhesive which will attach the floatation device 12 to the cap 10. The adhesive may be in the form of a liquid adhesive which is sprayed onto the attachment side 50. Alternatively, the adhesive may be a double sided tape or sheet wherein a first side 60 is adhered to the attachment side 50 of the body 40 and a second side 62 is attached to the release liner 44. The release liner 44 temporarily covers and protects the adhesive layer 42 until time of attachment. The release liner 44 is simply peeled away from the adhesive layer 42, as shown by broken lines 44a in FIG. 3, which then may be discarded. It has been found that a 3M brand double coated urethane foam adhesive tape, item number 4032, is suitable for the adhesive layer 42. The adhesive layer 42 may form a permanent bond such that the floatation cannot be removed from the bill 28 without destruction thereof. Alternatively, the adhesive layer 42 may provide for a non-permanent attachment such that the floatation device 12 may be removably attached to the bill 28 without tearing or destroying the floatation device 12 and/or cap 10 upon removal.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A floatation device for attachment to a bill of a cap for preventing the cap from sinking when dropped in a body of water, said floatation device comprising:
a sheet of buoyant material;
an adhesive layer adhered to a first side of said sheet; and
a removable release liner adhered to a second side of said adhesive layer such that said release liner can be removed to expose the adhesive layer for attachment of said sheet to the bill of the cap.

2. The device of claim 1, wherein said sheet is a planar sheet having a constant cross-sectional thickness.

3. The device of claim 1, wherein said sheet is made of cork.

4. The device of claim 3, wherein said sheet is made of agglomerated composition cork having a polyurethane binder.

5. The device of claim 4, wherein said sheet has a thickness of between about 0.0625 inches to about 0.125 inches.

6. The device of claim 1, wherein said sheet has a curved front edge and a curved rear edge.

7. The device of claim 1, wherein said adhesive layer is a double sided tape.

8. The device of claim 1, wherein said adhesive layer is a spray adhesive disposed onto said first side of said sheet.

9. The device of claim 1, wherein said adhesive layer is a removable adhesive.

10. A combined cap and floatation device comprising:
a cap including:
a rounded body having a front edge; and
a bill having a rear edge attached to said front edge of said body such that said bill extends outwardly from said body, said bill further including a front edge, side edges, and an underside surface; and
a floatation device attached to said bill for preventing the cap from sinking when dropped in a body of water, said floatation device including:
a sheet of buoyant material having a front edge, a rear edge, and side edges; and
an adhesive layer adhering said sheet to said underside surface of said bill, wherein said sheet is dimensioned to substantially cover said underside surface of said bill of said cap.

11. The combination of claim 10, wherein said sheet and said bill are made of flexible materials such that said sheet flexes upon flexing of said bill.

12. The combination of claim 10, wherein said rear edges of said sheet and said body have corresponding curved shapes.

13. The combination of claim 10, wherein said front edges of said sheet and said body have corresponding curved shapes.

14. The combination of claim 10, wherein said sheet is a planar sheet having a constant cross-sectional thickness, and wherein said sheet is made of agglomerated composition cork having a polyurethane binder.
